(19) United States
(12) Patent Application Publication
(10) Pub. No.: US 2016/0224119 A1
(43) Pub. Date: Aug. 4, 2016

(54) Apparatus for Unlocking User Interface and Associated Methods

(71) Applicant: NOKIA TECHNOLOGIES OY, Espoo (FI)

(72) Inventor: Wei Wu, Beijing (CN)

(21) Appl. No.: 14/917,471

(22) PCT Filed: Sep. 10, 2013
(86) PCT No.: PCT/CN2013/083192

§ 371 Date: Mar. 8, 2016

(51) Int. Cl. G06F 3/01; G06F 3/0481; G06F 21/36; G06F 3/14

(52) U.S. Cl. CPC G06F 3/017; G06F 3/14; G06F 3/0481; G06F 21/36

(57) ABSTRACT

An apparatus comprising at least one processor and at least one memory including computer program code, the at least one memory and the computer program code configured to, with the at least one processor, enable the apparatus at least to: based on a determined characteristic of a received user interface unlock gesture associated with unlocking a user interface of an electronic device, unlock and orientate a display of the user interface such that it is orientated on a display screen of the electronic device according to an orientation associated with the determined characteristic.

### TECHNICAL FIELD

The present disclosure relates to the field of user interfaces, associated methods and apparatus, and in particular concerns an apparatus configured to unlock and orientate the display of a user interface based on a determined characteristic of a received user interface unlock gesture. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones, other smart devices, and tablet PCs.

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture functions (e.g. using a (e.g. in-built) digital camera), and gaming functions.

### BACKGROUND

Many modern electronic devices are capable of displaying a user interface in different orientations. Many electronic devices provide a locking facility to disable the user interface when the device is not being handled.

The listing or discussion of a prior-published document or any background in this specification should not necessarily be taken as an acknowledgement that the document or background is part of the state of the art or is common general knowledge.

### SUMMARY

According to a first aspect, there is provided an apparatus comprising at least one processor and at least one memory including computer program code, the at least one memory and the computer program code configured to, with the at least one processor, enable the apparatus at least to: based on a determined characteristic of a received user interface unlock gesture associated with unlocking a user interface of an electronic device, unlock and orientate a display of the user interface such that it is orientated on a display screen of the electronic device according to an orientation associated with the determined characteristic.

Therefore, an orientation accelerometer is not necessarily required to determine the orientation of the device during the unlocking procedure and a user can control the orientation of the user interface by controlling the characteristic of the user interface unlock gesture.

The user interface unlock gesture may comprise a linear input and the determined characteristic may comprise an orientation of the linear input relative to a reference axis. The apparatus may be configured to orientate the display of the user interface according to the determined relative orientation of the linear input.

The reference axis may comprise a longitudinal or latitudinal axis of a display screen of an electronic device. This may be the electronic device with the user interface (i.e. the electronic device) or a different electronic device. The apparatus may be configured to orientate the display of the user interface in a longitudinal or latitudinal orientation when the linear input is determined to be substantially parallel to the longitudinal or latitudinal axis respectively.

The relative orientation of the linear input may comprise a direction of the linear input relative to the longitudinal or latitudinal axis. The apparatus may be configured to orientate the display of the user interface in a positive or negative longitudinal/latitudinal orientation according to the determined relative direction of the linear input.

The apparatus may be configured to orientate the display of the user interface such that the top of the user interface corresponds with the determined relative direction of the linear input.

The linear input may comprise a swipe input or first and second consecutive point inputs defining the start and end points of a vector.

The user interface unlock gesture may comprise a point input and the determined characteristic may comprise a position of the point input on a display screen of an electronic device. The apparatus may be configured to orientate the display of the user interface according to the determined position of the point input. The apparatus may be configured to orientate the display of the user interface such that the top of the user interface corresponds with the determined position of the point input. The apparatus may be configured to orientate the display of the user interface only if the point input has a duration which exceeds a minimum predetermined threshold.

The user interface unlock gesture may comprise a point input having a particular duration and the determined characteristic may comprise the duration of the point input. The apparatus may be configured to orientate the display of the user interface according to the determined duration of the point input.

The point input may comprise one or more of a touch/hover input and an input from a remote pointer. The remote pointer may e.g. be a mouse, wand or another apparatus associated with the electronic device.

The user interface unlock gesture may comprise a plurality of inputs and the determined characteristic may comprise the number of said inputs. The apparatus may be configured to orientate the display of the user interface according to the determined number of inputs. The apparatus may be configured to orientate the display of the user interface only if the determined number of inputs exceeds a minimum predetermined threshold.

The apparatus may be configured to provide an indicator before unlocking the user interface to indicate how the display of the user interface will be orientated once it has been unlocked.

The plurality of inputs may comprise one or more of claps (detected, for example, by a microphone), touch/hover inputs and inputs from a remote pointer.

The apparatus may be configured to orientate the display of the user interface such that one or more graphical user interface elements, one or more graphical user interface elements of a home screen, one or more application windows, and/or a content item displayed across the entire display screen is orientated based on the determined characteristic.

The apparatus may be configured to determine that a received user input gesture is a user interface unlock gesture. In other cases, a separate apparatus may be configured to make this determination. The apparatus may be configured to determine that the received user input gesture is a user interface unlock gesture by comparing the received user input gesture against a database of predetermined user interface unlock gestures to determine a match. The apparatus may be configured to determine that the received user input gesture is a user interface unlock gesture by determining whether the received user input gesture satisfies one or more predetermined user interface unlock gesture criteria. The apparatus may be configured to receive the user interface unlock gesture. The apparatus may comprise one or more of a physical contact touch sensitive display screen, a hover touch sensitive display screen and one or more position/motion sensors configured to receive the user interface unlock gesture. The apparatus may be configured to determine the characteristic of a received user interface unlock gesture. In other embodiments, the apparatus may be configured to receive the determined characteristic from another apparatus.

The electronic device may be one or more of a portable electronic device, a portable telecommunications device, a laptop computer, a tablet computer, a mobile phone and a portable digital assistant. The apparatus may be one or more of an electronic device, the electronic device, a portable electronic device, a portable telecommunications device, a laptop computer, a tablet computer, a mobile phone, a portable digital assistant, a server associated with the electronic device, and a module for any of the aforementioned devices. In some examples, the apparatus may be comprised in, or may be, the electronic device having a user interface. In some examples, the apparatus may be separate to and in communication with the electronic device, and may receive signalling indicating a determined characteristic of the received user interface unlock gesture and provide signalling to unlock and orient the display of the user interface of the electronic device.

According to a further aspect, there is provided an apparatus comprising means for: based on a determined characteristic of a received user interface unlock gesture associated with unlocking a user interface of an electronic device, unlocking and orientating a display of the user interface such that it is orientated on a display screen of the electronic device according to an orientation associated with the determined characteristic.

According to a further aspect, there is provided a method comprising: based on a determined characteristic of a received user interface unlock gesture associated with unlocking a user interface of an electronic device, unlocking and orientating a display of the user interface such that it is orientated on a display screen of the electronic device according to an orientation associated with the determined characteristic.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means and corresponding functional units for performing one or more of the discussed functions (e.g. a user interface display unlocker and orientator) are also within the present disclosure.

The above summary is intended to be exemplary and non-limiting.

### BRIEF DESCRIPTION OF THE FIGURES

A description is now given, by way of example only, with reference to the accompanying drawings, in which:

FIG. 1 shows a change in the orientation of a user interface from a longitudinal/portrait orientation to a latitudinal/landscape orientation resulting from a corresponding change in the device orientation;

FIG. 2 shows the unlocking of a user interface from a locked/inactive state to an unlocked/active state;

FIG. 3 shows an apparatus according to one example embodiment of the present disclosure;

FIG. 4 shows an apparatus according to another example embodiment of the present disclosure;

FIG. 5 shows an apparatus according to another example embodiment of the present disclosure;

FIG. 6a illustrates schematically an example of a swipe input gesture applied to a touch/hover-sensitive display;

FIG. 6b illustrates schematically an example of a multi-point input gesture applied to a touch/hover-sensitive display;

FIG. 7a illustrates schematically an example of a range of linear gesture orientations corresponding with the longitudinal and latitudinal axes of a display screen;

FIG. 7b illustrates schematically an example of a range of linear gesture directions corresponding with the positive and negative longitudinal/latitudinal directions of a display screen;

FIG. 7c illustrates schematically an example of the longitudinal and latitudinal axes of a square display screen;

FIG. 8a shows an example of the unlocking of a user interface to provide a longitudinal orientation following the detection of a longitudinal unlock gesture;

FIG. 8b shows an example of the unlocking of a user interface to provide a latitudinal orientation following the detection of a latitudinal unlock gesture;

FIG. 9a shows an example of the unlocking of a user interface to provide a positive longitudinal orientation following the detection of a positive longitudinal unlock gesture;

FIG. 9b shows an example of the unlocking of a user interface to provide a negative longitudinal orientation following the detection of a negative longitudinal unlock gesture;

FIG. 10 illustrates schematically an example of four quadrants of a display screen for receiving a point input gesture;

FIG. 11a shows an example of the unlocking of a user interface to provide a positive latitudinal orientation following the detection of a point input gesture in the second quadrant;

FIG. 11b shows an example of the unlocking of a user interface to provide a negative latitudinal orientation following the detection of a point input gesture in the fourth quadrant;

FIG. 12a shows an example of the unlocking of a user interface to provide a negative longitudinal orientation following the detection of a point input gesture having a first duration;

FIG. 12b shows an example of the unlocking of a user interface to provide a positive latitudinal orientation following the detection of a point input gesture having a second duration;

FIG. 13a shows an example of the unlocking of a user interface to provide a negative latitudinal orientation following the detection of an unlock gesture comprising five point inputs;

FIG. 13b shows an example of the unlocking of a user interface to provide a positive longitudinal orientation following the detection of a point input gesture comprising two point inputs;

FIG. 14a shows an example embodiment of a system comprising the apparatus described herein;

FIG. 14b shows another example embodiment of a system comprising the apparatus described herein;

FIG. 15 shows example steps of a method of unlocking and orientating the display of a user interface using the apparatus described herein; and

FIG. 16 shows a computer-readable medium comprising a computer program configured to perform, control or enable one or more of the method steps of FIG. 15.

### DESCRIPTION OF SPECIFIC ASPECTS/EMBODIMENTS

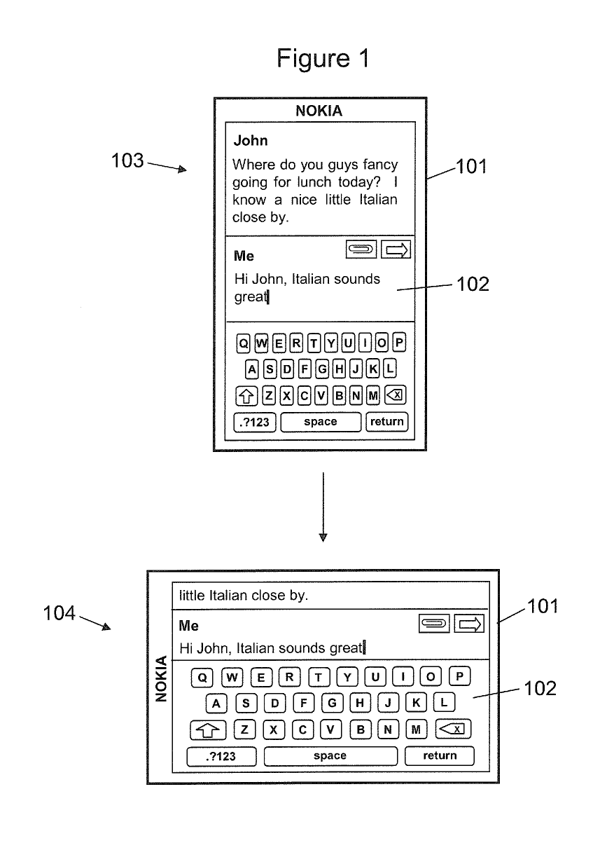

Many modern electronic devices 101 are capable of displaying a user interface 102 in two or more different orientations 103, 104. For example, some devices 101 provide portrait/longitudinal 103 and landscape/latitudinal 104 orientations to suit the orientation of the device 101 in the user's hands and/or the content that is being displayed. Typically, the orientation of a device 101 is determined using an accelerometer. This is illustrated in FIG. 1 in which the orientation of a text application interface 102 is switched from portrait mode 103 to landscape mode 104 as the device 101 undergoes a corresponding change in orientation.

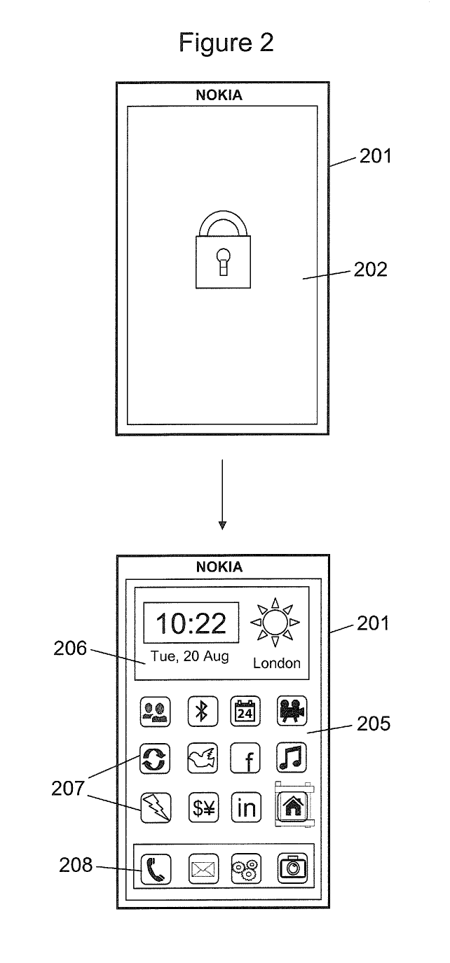

Many electronic devices 201 also provide a locking facility to disable the user interface 202 when the device 201 is not being handled. This helps to prevent unintentional (or even unauthorised) activation of the device features, e.g. due to contact between the user interface 202 and another object whilst the device 201 is in a pocket or bag (or by restricting access to particular users). For touchscreen devices 201, the user interface 202 can usually be unlocked by providing a touch input gesture such as a swipe input. In the example shown in FIG. 2, a user interface 202 is unlocked to provide a home screen 205 comprising graphical user interface elements such as widget icons 206, application icons 207 and shortcuts 208.

One issue with the above-mentioned devices is that the user interface 202 can sometimes be orientated incorrectly immediately after unlocking due to the orientation of the device 201 when or before it was unlocked by the user. For example, if the device was taken out of a pocket or bag, it may have been upside down during the unlocking procedure. Similarly, if the device was lying on a table during the unlocking procedure, it could have had any in-plane orientation. As a result, the user needs to manually rotate or shake the device 201 in order to obtain the desired orientation before the device 201 can be used.

One or more aspects/embodiments of the present disclosure may or may not address this issue.

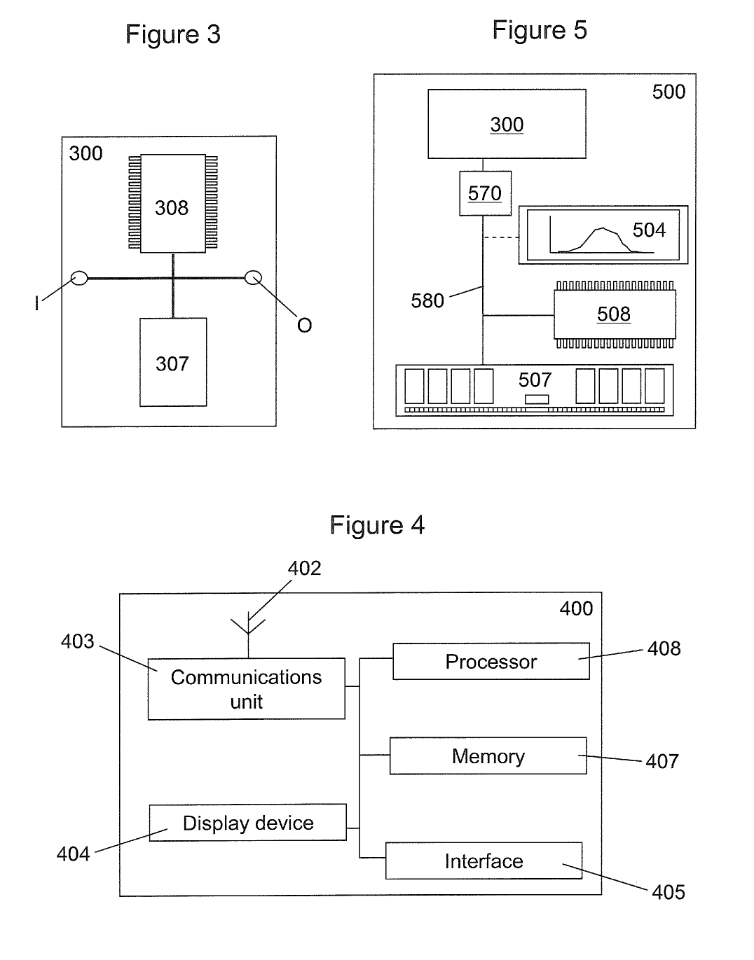

FIG. 3 shows an apparatus 300 according to one embodiment of the present disclosure comprising memory 307, a processor 308, input I and output O. In this embodiment only one processor and one memory are shown but it will be appreciated that other embodiments may utilise more than one processor and/or more than one memory (e.g. same or different processor/memory types).

In this embodiment the apparatus 300 is an Application Specific Integrated Circuit (ASIC) for a portable electronic device. In other embodiments the apparatus 300 can be a module for such a device, or may be the device itself, wherein the processor 308 is a general purpose CPU of the device and the memory 307 is general purpose memory of by the device.

The input I allows for receipt of signalling to the apparatus 300 from further components, such as components of a portable electronic device (like a touch-sensitive or hover-sensitive display) or the like. The output O allows for onward provision of signalling from within the apparatus 300 to further components such as a display screen, speaker, or vibration module. In this embodiment the input I and output O are part of a connection bus that allows for connection of the apparatus 300 to further components.

The processor 308 is a general purpose processor dedicated to executing/processing information received via the input I in accordance with instructions stored in the form of computer program code on the memory 307. The output signalling generated by such operations from the processor 308 is provided onwards to further components via the output O.

The memory 307 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 308, when the program code is run on the processor 308. The internal connections between the memory 307 and the processor 308 can be understood to, in one or more example embodiments, provide an active coupling between the processor 308 and the memory 307 to allow the processor 308 to access the computer program code stored on the memory 307.

In this example the input I, output I, processor 308 and memory 307 are all electrically connected to one another internally to allow for electrical communication between the respective components I, O, 107, 308. In this example the components are all located proximate to one another so as to be formed together as an ASIC, in other words, so as to be integrated together as a single chip/circuit that can be installed into an electronic device. In other examples one or more or all of the components may be located separately from one another.

FIG. 4 depicts an apparatus 400 according to another example embodiment of the present disclosure. In this example, the apparatus 400 is a portable electronic device (e.g. mobile phone, PDA or audio/video player), but in other example embodiments, the apparatus 400 may be a module for a portable electronic device, and may just comprise a suitably configured memory 407 and processor 408.

The example embodiment of FIG. 4 comprises a display device 404 such as, for example, a liquid crystal display (LCD), e-Ink, a hover touch or a touch-screen user interface. The apparatus 400 is configured such that it may receive, include, and/or otherwise access data. For example, this example embodiment 400 comprises a communications unit 403, such as a receiver, transmitter, and/or transceiver, in communication with an antenna 402 for connecting to a wireless network and/or a port (not shown) for accepting a physical connection to a network, such that data may be received via one or more types of networks. This example embodiment comprises a memory 407 that stores data, possibly after being received via antenna 402 or port or after being generated at the user interface 405. The processor 408 may receive data from the user interface 405, from the memory 407, or from the communication unit 403. It will be appreciated that, in certain example embodiments, the display device 404 may incorporate the user interface 405. Regardless of the origin of the data, these data may be outputted to a user of apparatus 400 via the display device 404, and/or any other output devices provided with apparatus. The processor 408 may also store the data for later use in the memory 407. The memory 407 may store computer program code and/or applications which may be used to instruct/enable the processor 408 to perform functions (e.g. read, write, delete, edit or process data).

FIG. 5 depicts a further example embodiment of the present apparatus 500. In this embodiment, the apparatus 500 is an electronic device comprising the apparatus 300 of FIG. 3. The electronic device may be one or more of a portable electronic device, a portable telecommunication device, a laptop computer, a tablet computer, a mobile phone, a portable digital assistant, a television, a refrigerator and/or the like. The apparatus 300 can be provided as a module for device 500, or even as a processor/memory for the device 500 or a processor/memory for a module for such a device 500. The device 500 comprises a processor 508 and a storage medium 507, which are connected (e.g. electrically and/or wirelessly) by a data bus 580. This data bus 580 can provide an active coupling between the processor 508 and the storage medium 507 to allow the processor 508 to access the computer program code. It will be appreciated that the components (e.g. memory, processor) of the device/apparatus may be linked via cloud computing architecture. For example, the storage device may be a remote server accessed via the internet by the processor.

The apparatus 300 is connected (e.g. electrically and/or wirelessly) to an input/output interface 570 that receives the output from the apparatus 300 and transmits this to other components of device 500 via data bus 580. Interface 570 can be connected via the data bus 580 to a display 504 (touch-sensitive or otherwise) that provides information from the apparatus 300 to a user. Display 504 can be part of the device 500 or can be separate. The processor 508 is configured for general control of the device 500 by providing signalling to, and receiving signalling from, the various components to manage their operation.

The storage medium 507 is configured to store computer code configured to perform, control or enable the operation of the device 500. The storage medium 507 may be configured to store settings for the other device components. The processor 508 may access the storage medium 507 to retrieve the component settings in order to manage the operation of the other device components. The storage medium 507 may be a temporary storage medium such as a volatile random access memory. The storage medium 507 may also be a permanent storage medium such as a hard disk drive, a flash memory, a remote server (such as cloud storage) or a non-volatile random access memory. The storage medium 507 could be composed of different combinations of the same or different memory types.

As mentioned in the background section, the user interface of a modern electronic device can sometimes be orientated incorrectly immediately after unlocking due to the orientation of the device when or before it was unlocked by the user. In this scenario, the user needs to manually rotate or shake the device in order to obtain the desired orientation before the device can be used. Also, accelerometers are often used to determine the orientation of a device. The apparatus and associated methods described herein may or may not address this issue.

For example, a user may pick up an apparatus/electronic device and want the display of the apparatus be oriented correctly regardless of the orientation of the device and her orientation so that she can start using the device immediately after unlocking. The device may be freely oriented, e.g. having multiple microphones and speakers, so that the user can use it in any orientation she chooses. According to example embodiments disclosed herein, the user may grab the device in any orientation and, using an unlock gesture having a particular unlocking direction with respect to the device, cause the display to be oriented in the orientation (e.g. portrait) she prefers. Another example according to the present disclosure may involve an apparatus/electronic device resting on a table. The user may want to view the display of the device in landscape, or portrait, in relation to her viewpoint. In this case the direction of the unlocking gesture (the direction being a characteristic of the received user interface unlock gesture) enables the device to be unlocked and display the user interface in a desired orientation according to the gesture direction.

In some example embodiments, the apparatus/electronic device may be provided with an accelerometer, a magnetometer, and/or other sensors that may detect orientation of the electronic device. For example, the magnetometer values may be detected before an unlocking gesture and after the unlocking gesture, and based on the detected values and the unlocking gesture, the device may be unlocked to show a user interface having an orientation according to the user's preference. For example, the user may wish to see a portrait user interface presentation regardless of the display of the device being ‘upside-down’ in relation to the user.

The apparatus of the present disclosure is configured to unlock and orientate the display of a user interface of an electronic device based on a determined characteristic of a received user interface unlock gesture such that the user interface is orientated on a display screen of an electronic device according to an orientation associated with the determined characteristic. Modern graphical user interfaces typically comprise one or more home screens comprising graphical user interface elements (e.g. widget icons, application icons and shortcuts), application windows, and content items displayed across the entire display screen. In this respect, the present apparatus may be configured to orientate the display of a graphical user interface such that one or more of the above-mentioned features are orientated based on the determined characteristic.

The user interface unlock gesture can take a number of different forms including a tap, a swipe, a slide, a press, a hold, a rotate gesture, a static hover gesture proximal to the user interface of the device, a moving hover gesture proximal to the device, bending at least part of the device, squeezing at least part of the device, a multi-finger gesture, tilting the device or flipping the device. In order to detect one or more of these gestures, the apparatus/electronic device may comprise a physical contact or hover touch-sensitive display having an array of touch sensors (e.g. capacitive sensors). The user interface unlock gesture is not limited to interactions with a touch-sensitive display, however. For example, the gesture may involve the use of a remote wand for interaction with a display screen which could be used to provide single point inputs, multi-point inputs, swipe inputs or rotate gestures. In this scenario, the apparatus/electronic device may comprise LEDs (e.g. infrared LEDs) and associated sensors for detecting one or more of translational motion, rotational motion and angular motion of the remote wand. The user interface unlock gesture could also be detected using a 3D capacitive touch sensor which generates a capacitive field, which may be considered to be a virtual mesh. This capacitive field/virtual mesh may be used to determine the nature/characteristic of the particular 3D input for unlocking and orientating the display of the user interface.

In some examples, the user interface unlock gesture may, in addition to determining the orientation of the user interface once unlocked, also affect the mode which the device is in after being unlocked. For example, a user could define that a particular home screen view or open application is presented after unlocking the device using a particular unlock gesture. As another example, the application or view which was presented just prior to the device being locked may be presented after the device is unlocked, and the presentation may be dependent on the particular unlock gesture used (accounting for the direction of the unlock gesture and/or the particular type of unlock gesture used).

For example, a calendar application may have been displayed just prior to the device being locked (or a user may have associated a particular unlocking gesture with opening a calendar application upon unlocking the device). Upon unlocking the device using a upwards swipe gesture, an agenda view in portrait orientation may be presented, unlocking the device using a swipe gesture to the right may cause a monthly view to be presented in a landscape format, and unlocking the device using a swipe gesture to the left may cause a day by day view to be presented in a landscape format, for example. Other applications may have similar application modes which are presented upon the device being unlocked using a particular unlock gesture. For example, an e-mail application may present an overview screen, an inbox, an outbox, or a particular archive file, dependent on the unlock gesture used. As another example, a social media application may present a user's overall news feed, a user's personal profile, or the profile page of a particular contact dependent on the particular unlock gesture used.

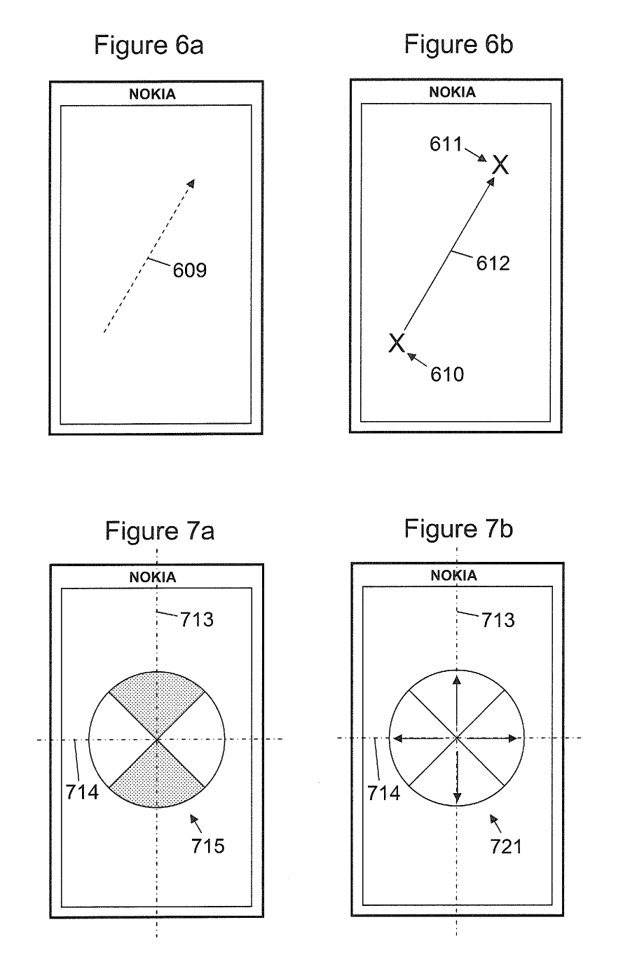

FIGS. 6a and 6b provide examples of user interface unlock gestures comprising a linear input. In FIG. 6a, the user interface unlock gesture is a swipe gesture 609 (e.g. continuous touch, hover or remote input), whilst in FIG. 6b, the user interface unlock gesture comprises first 610 and second 611 point inputs (e.g. discrete touch, hover or remote inputs) defining the start and end points of a vector 612. When the user interface unlock gesture comprises a linear input, the determined characteristic may comprise the orientation of the linear input relative to a reference axis, and the apparatus may be configured to orientate the display of the user interface according to the determined relative orientation of the linear input.

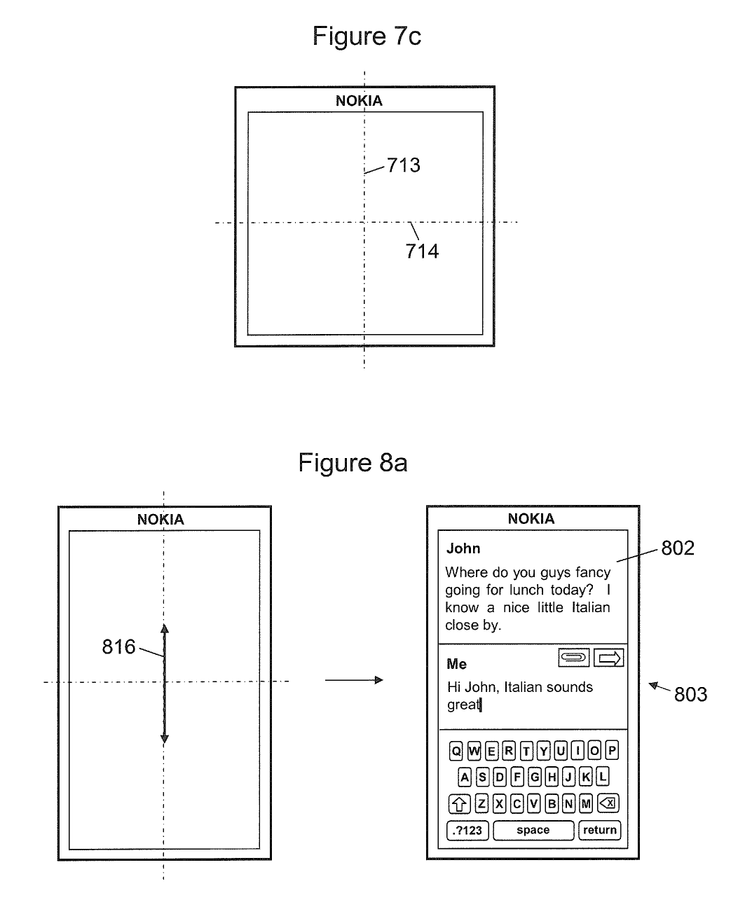

As shown in FIG. 7a, the reference axis can be the longitudinal 713 or latitudinal 714 axis of a display screen. The terms “longitudinal” and “latitudinal” do not necessarily refer to the long and short axes of the display screen, respectively. Rather, they can be used to distinguish between the up-down (i.e. top-to-bottom) and left-right (i.e. side-to-side) axes in the plane of the display. As a result, this nomenclature is also applicable to square-shaped display screens/devices, as shown in FIG. 7c. The apparatus may be configured to orientate the display of the user interface in a longitudinal 713 or latitudinal 714 orientation when the linear input is determined to be substantially parallel to the longitudinal or latitudinal axis, respectively. The expression “substantially parallel” may be taken to mean within +/−45° of the axis, as illustrated by the shaded (longitudinal axis) and unshaded (latitudinal axis) sectors of the circle 715 shown in FIG. 7a. This ensures that linear inputs of any orientation result in either a longitudinal or latitudinal user interface orientation.

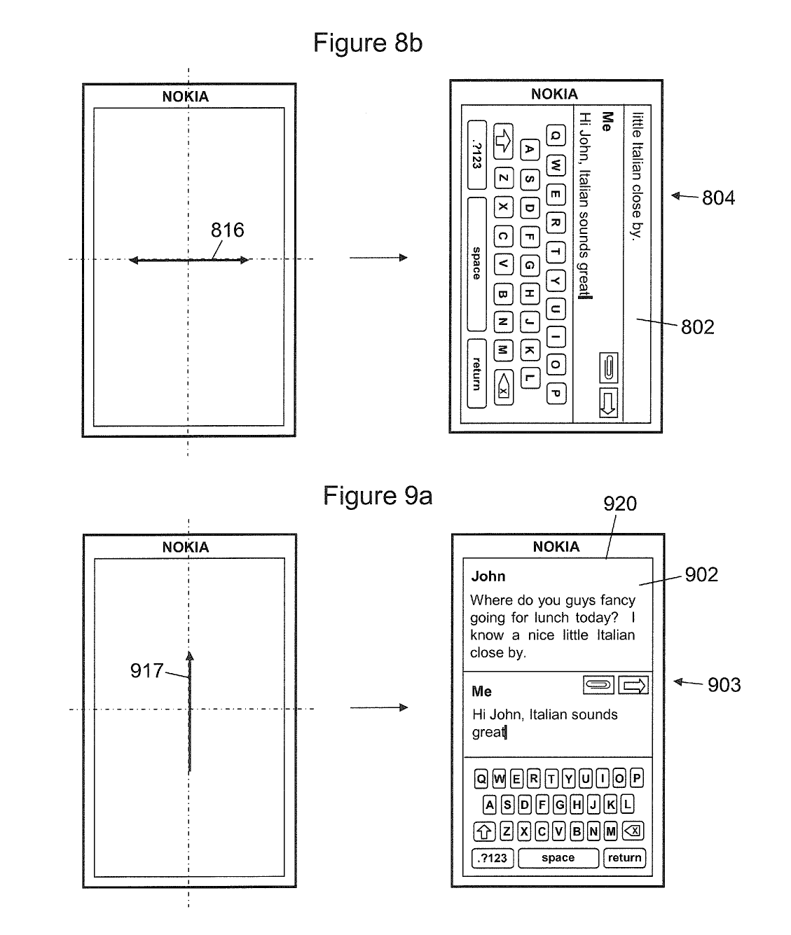

It should be noted, however, that the apparatus of FIG. 7a does not distinguish between the positive and negative longitudinal/latitudinal directions (i.e. up v down or left v right, respectively). Rather, it merely determines whether the linear input is aligned with the respective axis of the display screen. As a result, this embodiment is able to provide one longitudinal/portrait user interface orientation and one latitudinal/landscape user interface orientation. This is illustrated in FIGS. 8a and 8b. In FIG. 8a, the apparatus unlocks the user interface 802 to provide a positive longitudinal orientation 803 (up) regardless of whether the linear input 816 was orientated in a positive (up) or negative (down) longitudinal direction. Similarly, in FIG. 8b, the apparatus unlocks the user interface 802 to provide a positive latitudinal orientation 804 (right) regardless of whether the linear input 816 was orientated in a positive (right) or negative (left) latitudinal direction.

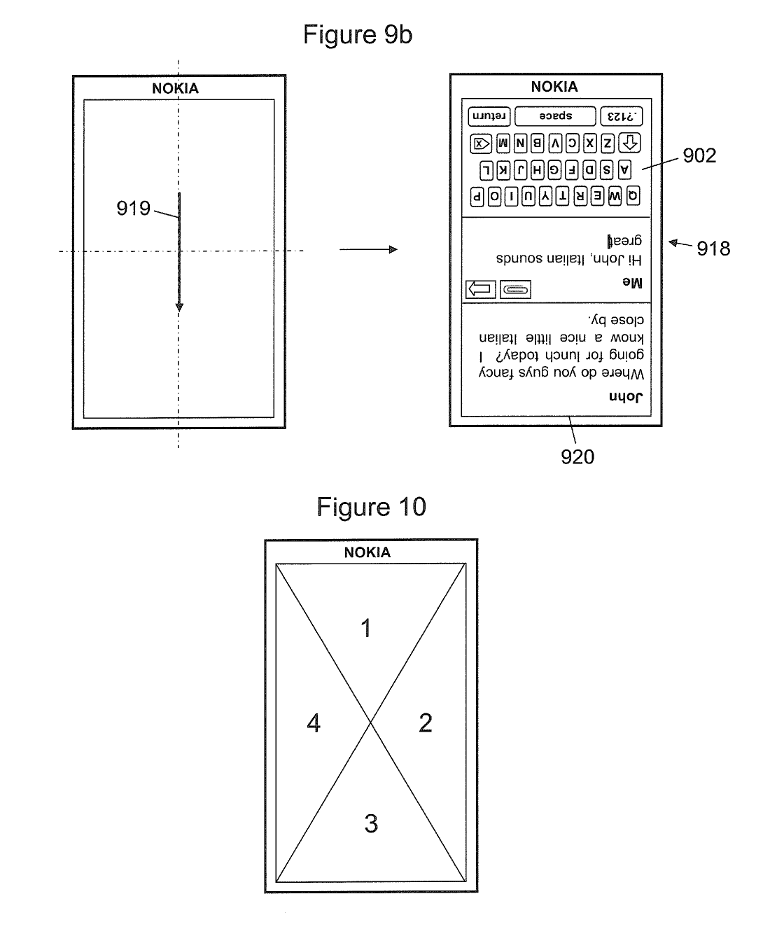

In one or more embodiments, the apparatus/electronic device may be configured to provide user interface orientations in all four in-plane directions. In these embodiments, the direction of the linear input relative to the longitudinal or latitudinal axis is determined as well as the general alignment. This is illustrated in FIGS. 9a and 9b. In FIG. 9a, the apparatus unlocks the user interface 902 to provide a positive longitudinal orientation 903 (up) on detection of a positive longitudinal unlock gesture 917. Similarly, in FIG. 9b, the apparatus unlocks the user interface 902 to provide a negative longitudinal orientation 918 (down) on detection of a negative longitudinal unlock gesture 919. In each of these examples, the apparatus is configured to orientate the display of the user interface such that the top 920 of the user interface 902 corresponds with the determined relative direction of the linear input 917/919.

To ensure that all linear inputs result in a positive or negative longitudinal/latitudinal user interface orientation, the apparatus/electronic device may be configured to determine that a linear input is “substantially parallel” to one of the axial directions if it is orientated within +/−45° of said direction, as defined by the sectors of the circle 721 shown in FIG. 7b.

As indicated above, the user interface unlock gestures may comprise point inputs (e.g. one or more discrete touch, hover or remote inputs) rather than linear inputs. When the user interface unlock gesture comprises a point input, the determined characteristic may comprise the position of the point input on a display screen of an electronic device, and the apparatus may be configured to orientate the display of the user interface according to the determined position of the point input.

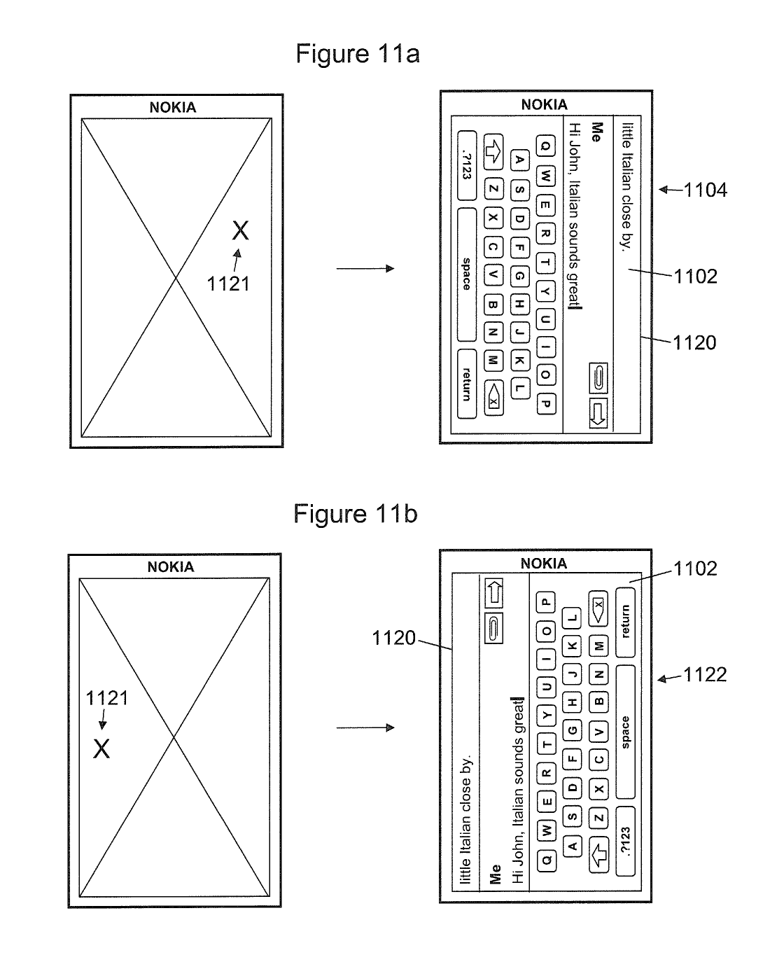

In one embodiment, the display screen may be divided into four quadrants (1-4) as shown in FIG. 10, each quadrant corresponding with a particular user interface orientation. In this scenario, the apparatus may be configured to orientate the user interface based on the quadrant in which the point input was detected. For example, the apparatus may be configured to orientate the user interface 1102 such that the top 1120 of the user interface 1102 corresponds with the selected quadrant. This is illustrated in FIGS. 11a and 11b. In FIG. 11a, the apparatus unlocks the user interface 1102 to provide a positive latitudinal orientation 1104 (right) on detection of a point input 1121 in the second quadrant. Similarly, in FIG. 11b, the apparatus unlocks the user interface 1102 to provide a negative latitudinal orientation 1122 (left) on detection of a point input 1121 in the fourth quadrant. To prevent against unintentional activation of the user interface (e.g. due to contact with the user's fingers as he/she picks up or holds the device, or due to contact with another object whilst the device is in a pocket or bag), the apparatus/electronic device may be configured such that the point input 1121 only registers as a user interface unlock gesture if it has a duration which exceeds a minimum predetermined threshold.

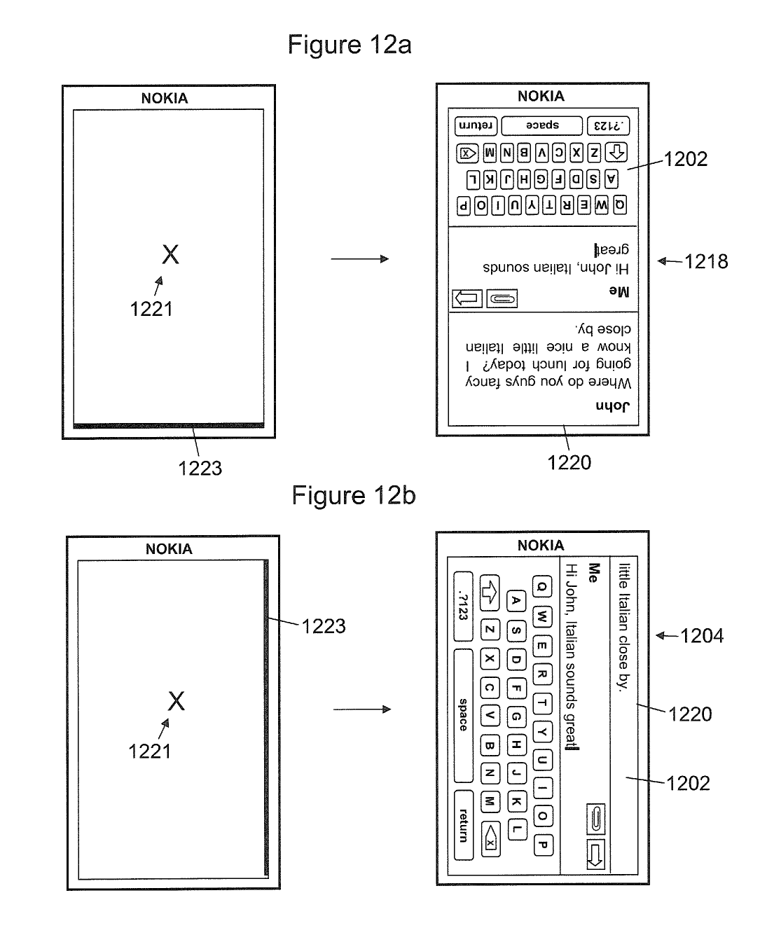

In another embodiment, the user interface unlock gesture may comprise a point input (e.g. a discrete touch, hover or remote input) having a particular duration, and the determined characteristic may comprise the duration of the point input. In this situation, the apparatus may be configured to orientate the display of the user interface according to the determined duration of the point input. This is illustrated in FIGS. 12a and 12b.

In FIG. 12a, the apparatus unlocks the user interface 1202 to provide a negative longitudinal orientation 1218 (down) on detection of a point input 1221 having a first duration. Similarly, in FIG. 12b, the apparatus unlocks the user interface 1202 to provide a positive latitudinal orientation 1204 (right) on detection of a point input 1221 having a second duration.

To help the user to select a particular user interface orientation, the apparatus (or the electronic device) may be configured to provide some kind of indicator corresponding to the duration of the point input. For example, the apparatus/electronic device may be configured to highlight an edge 1223 of the display screen to indicate where the top 1220 of the user interface 1202 will be located, as shown in FIGS. 12a and 12b. The edge 1223 which is highlighted will therefore change with time until the user terminates the point input 1221, at which time the user interface will be unlocked and orientated with the top 1220 of the user interface 1202 located adjacent to the edge 1223 that was last highlighted. This progressive highlighting may be progressively repeated until a selection is made.

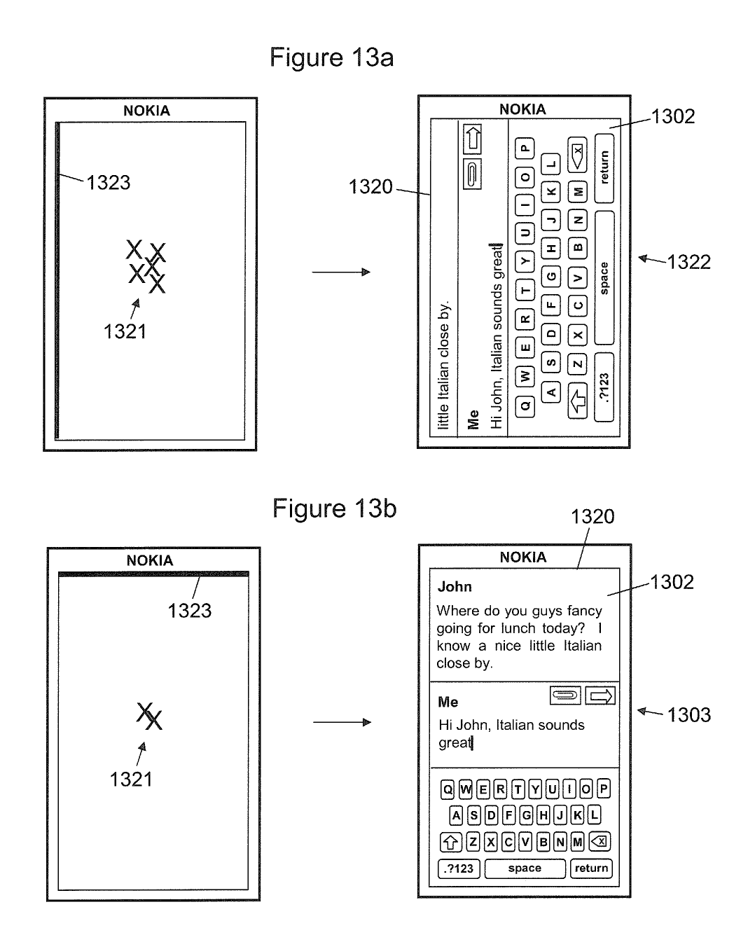

In a further embodiment, the user interface unlock gesture may comprise a plurality of inputs (e.g. discrete touch, hover or remote point inputs), and the determined characteristic may comprise the number of said inputs. In this situation, the apparatus may be configured to orientate the display of the user interface according to the determined number of inputs. This is illustrated in FIGS. 13a and 13b. In FIG. 13a, the apparatus unlocks the user interface 1302 to provide a negative latitudinal orientation 1322 (left) on detection of an unlock gesture comprising five point inputs 1321. Similarly, in FIG. 13b, the apparatus unlocks the user interface 1302 to provide a positive longitudinal orientation 1303 (up) on detection of an unlock gesture comprising two point inputs 1321. In this embodiment, the apparatus/electronic device may be configured such that a minimum number of inputs are required to unlock the user interface (e.g. at least two). This helps to prevent against unintentional activation of the user interface (e.g. due to contact with the user's fingers as he/she picks up or holds the device, or due to contact with another object whilst the device is in a pocket or bag).

To help the user to select a particular user interface orientation, the apparatus/electronic device may be configured to provide some kind of indicator corresponding to the number of inputs. As in the previous embodiment, the apparatus/electronic device may be configured to highlight an edge 1323 of the display screen to indicate where the top 1320 of the user interface 1302 will be located. The edge 1323 which is highlighted will therefore change with each input until the user terminates the user interface unlock gesture, at which time the user interface 1302 will be unlocked and orientated with the top 1320 of the user interface 1302 located adjacent to the edge 1323 that was last highlighted. In this example, termination of the user interface unlock gesture may be determined from a predetermined duration with no further inputs.

As described above, the present technique can be implemented in a number of different ways (e.g. see the embodiments of FIGS. 8, 9, 11, 12 and 13). Given that end users may have different preferences, however, the apparatus/electronic device may be configured to enable the end user to select a particular implementation. For example, the apparatus/electronic device could be configured to provide each of the different user interface unlock/orientation options described herein and allow the user to select one of these options. The apparatus may even allow the end user to define his/her own user interface unlock gestures and associated user interface orientations.

In addition to unlocking and orientating the display of the user interface, the apparatus may be configured to receive a user input gesture, and determine whether the received user input gesture is a user interface unlock gesture. In practice, this may be achieved by comparing the received user input gesture against a database of predetermined user interface unlock gestures to determine a match, or by determining whether the received user input gesture satisfies one or more predetermined user interface unlock gesture criteria. The apparatus may also be configured to determine the characteristic (e.g. the orientation, direction, position, duration or number of inputs) of the received user interface unlock gesture. Alternatively, these functions may be performed by one or more other devices with the apparatus being used solely/primarily for unlocking and orientation purposes.

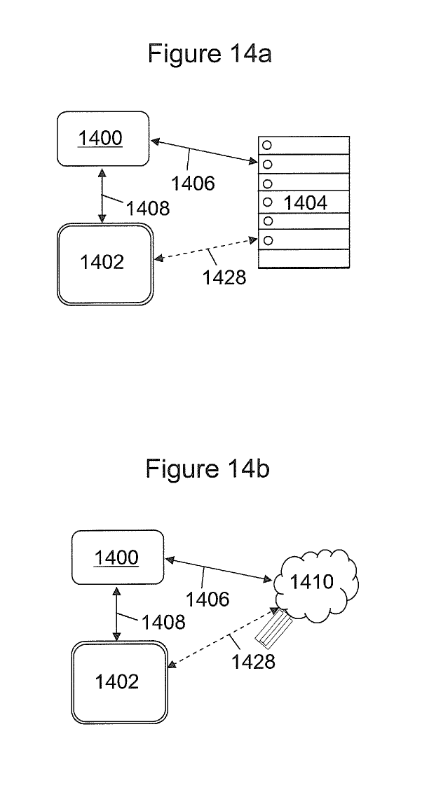

FIG. 14a shows one example embodiment of a system comprising the apparatus 1400 described herein (e.g. apparatus 300, 400 or 500) in which the apparatus 1400 is in communication 1406, 1408 (e.g. via the internet, Bluetooth, NFC, a USB connection, a telecommunications network, or any other suitable connection) with an electronic device 1402 and a remote server 1404. The electronic device 1402 may be one or more of a portable electronic device, a portable telecommunications device, a laptop computer, a tablet computer, a mobile phone, a portable digital assistant, a television, a refrigerator and/or the like; and the apparatus 1400 may be one or more of these devices or a module for the same. In other examples, the apparatus 1400 may form part of the electronic device 1402.

The electronic device 1402 comprises the user interface, and the apparatus 1400 is configured to: receive a user input gesture; determine whether the received user input gesture is a user interface unlock gesture; determine a characteristic of the received user interface unlock gesture; unlock the user interface of the electronic device 1402; and orientate a display of the user interface according to an orientation associated with the determined characteristic. The remote server 1404 may be used to assist the apparatus 1400 in performing one or both of the determining steps. The remote server 1404 may be optional in this example, and the determining steps may be performed by apparatus 1400.

FIG. 14b shows an example of a similar system comprising the apparatus 1400 described herein. This time, however, the apparatus is in communication 1406, 1408 with the electronic device 1402 and a remote cloud 1410 (which may, for example, be the Internet, or a system of remote computers/servers configured for cloud computing). Like the remote server 1404 of the previous system, the cloud 1410 may be used to assist the apparatus 1400 in performing one or both of the determining steps. In both systems, the electronic device 1402 may also be in direct communication 1428 with the remote server 1404/cloud 1410. This feature may be used to download and update software on the electronic device 1402, including the user interface itself.

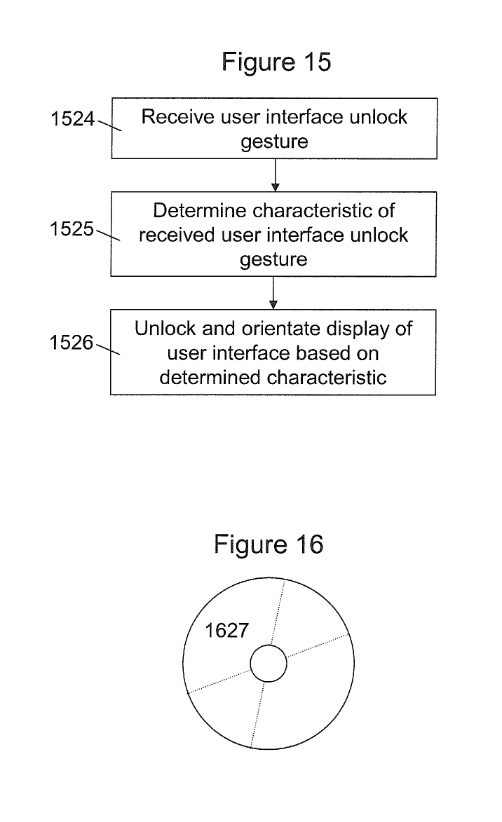

The main steps 1524-1526 of a method of unlocking and orientating the user interface of an electronic device using the present apparatus are shown schematically in FIG. 15. Steps 1524 and 1525 may not be performed by the apparatus in certain embodiments, but the information derived from these steps would, of course, be made available to the apparatus to perform step 1526.

FIG. 16 illustrates schematically a computer/processor readable medium 1627 providing a computer program according to one embodiment. In this example, the computer/processor readable medium 1627 is a disc such as a digital versatile disc (DVD) or a compact disc (CD). In other embodiments, the computer/processor readable medium 1627 may be any medium that has been programmed in such a way as to carry out an inventive function. For example, the computer/processor readable medium 1627 may be a removable memory device such as a memory stick or memory card (SD, mini SD, micro SD or nano SD). Furthermore, the computer program code may be distributed between multiple memories of the same type or multiple memories of a different type, such as ROM, RAM, flash, hard disk, solid state, etc.

The computer program may comprise computer code configured to perform, control or enable one or more of the method steps 1524-1526 of FIG. 15. In particular, the computer program may be configured to unlock and orientate the display of a user interface of an electronic device based on a determined characteristic of a received user interface unlock gesture.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-22. (canceled)

23. An apparatus comprising:
at least one processor and
at least one memory including computer program code, the at least one memory and the computer program code configured to, with the at least one processor, enable the apparatus at least to:
receive a user input gesture associated with unlocking a user interface of an electronic device;
determine a characteristic of the user input gesture;
based on the determined characteristic of the user input gesture, unlock and orientate a display of the user interface such that it is orientated on a display screen of the electronic device according to an orientation associated with the determined characteristic.

24. The apparatus of claim 23, wherein the user input gesture comprises a linear input and the determined characteristic comprises an orientation of the linear input relative to a reference axis, and wherein the apparatus is configured to orientate the display of the user interface according to the determined relative orientation of the linear input.

25. The apparatus of claim 24, wherein the reference axis comprises a longitudinal or latitudinal axis of a display screen of an electronic device, and wherein the apparatus is configured to orientate the display of the user interface in a longitudinal or latitudinal orientation when the linear input is determined to be substantially parallel to the longitudinal or latitudinal axis respectively.

26. The apparatus of claim 25, wherein the relative orientation of the linear input comprises a direction of the linear input relative to the longitudinal or latitudinal axis, and wherein the apparatus is configured to orientate the display of the user interface in a positive or negative longitudinal/latitudinal orientation according to the determined relative direction of the linear input.

27. The apparatus of claim 26 wherein the apparatus is configured to orientate the display of the user interface such that the top of the user interface corresponds with the determined relative direction of the linear input.

28. The apparatus of claim 24, wherein the linear input comprises a swipe input or first and second consecutive point inputs defining the start and end points of a vector.

29. The apparatus of claim 23, wherein the user input gesture comprises a point input and the determined characteristic comprises a position of the point input on a display screen of an electronic device, and wherein the apparatus is configured to orientate the display of the user interface according to the determined position of the point input.

30. The apparatus of claim 29, wherein the apparatus is configured to orientate the display of the user interface such that the top of the user interface corresponds with the determined position of the point input.

31. The apparatus of claim 29, wherein the apparatus is configured to orientate the display of the user interface only if the point input has a duration which exceeds a minimum predetermined threshold.

32. The apparatus of claim 23, wherein the user input gesture comprises a point input having a particular duration and the determined characteristic comprises the duration of the point input, and wherein the apparatus is configured to orientate the display of the user interface according to the determined duration of the point input.

33. The apparatus of claim 23, wherein the user input gesture comprises a plurality of inputs and the determined characteristic comprises the number of said inputs, and wherein the apparatus is configured to orientate the display of the user interface according to the determined number of inputs.

34. The apparatus of claim 33, wherein the apparatus is configured to orientate the display of the user interface only if the determined number of inputs exceeds a minimum predetermined threshold.

35. The apparatus of claim 23, wherein the apparatus is configured to provide an indicator before unlocking the user interface to indicate how the display of the user interface will be orientated once it has been unlocked.

36. The apparatus of claim 23, wherein the apparatus is configured to orientate the display of the user interface such that one or more graphical user interface elements, one or more graphical user interface elements of a home screen, one or more application windows, and/or a content item displayed across the entire display screen is orientated based on the determined characteristic.

37. The apparatus of claim 23, wherein the apparatus is configured to determine that a received user input gesture is a user interface unlock gesture.

38. The apparatus of claim 37, wherein the apparatus is configured to determine that the received user input gesture is a user interface unlock gesture by comparing the received user input gesture against a database of predetermined user interface unlock gestures to determine a match and/or by determining whether the received user input gesture satisfies one or more predetermined user interface unlock gesture criteria.

39. The apparatus of claim 23, wherein the apparatus comprises one or more of a physical contact touch sensitive display screen, a hover touch sensitive display screen and one or more position/motion sensors configured to receive the user interface unlock gesture.

40. A method comprising:
receiving a user input gesture associated with unlocking a user interface of an electronic device;
determining a characteristic of the user input gesture;
based on the determined characteristic of the user input gesture, unlocking and orientating a display of the user interface such that it is orientated on a display screen of the electronic device according to an orientation associated with the determined characteristic.

41. A non-transitory computer readable medium comprising computer program code configured to:
receive a user input gesture associated with unlocking a user interface of an electronic device;
determine a characteristic of the user input gesture;
based on the determined characteristic of the user input gesture, unlock and orientate a display of the user interface such that it is orientated on a display screen of the electronic device according to an orientation associated with the determined characteristic.
